(19) United States
(12) Patent Application Publication
(10) Pub. No.: US 2019/0311418 A1
(43) Pub. Date: Oct. 10, 2019

(54) TREND IDENTIFICATION AND MODIFICATION RECOMMENDATIONS BASED ON INFLUENCER MEDIA CONTENT ANALYSIS

(71) Applicant: International Business Machines Corporation, Armonk, NY (US)

(72) Inventors: Sushain PANDIT, Austin, TX (US); Fang WANG, Austin, TX (US); Vijay EKAMBARAM, Chennai (IN); Sarbajit K. RAKSHIT, Kolkata (IN)

(21) Appl. No.: 16/449,419

(22) Filed: Jun. 23, 2019

Related U.S. Application Data
(63) Continuation of application No. 15/949,071, filed on Apr. 10, 2018.

(51) Int. Cl. G06Q 30/06; G06Q 50/00; G06Q 30/02

(52) U.S. Cl. CPC G06Q 30/0631; G06Q 30/0205; G06Q 50/01

(57) ABSTRACT

Metadata of influencer media content from content platforms are analyzed, a potential product is identified, and attributes for the potential product is extracted. Profile data of followers of the influencer is obtained, and the followers are clustered. An influence factor of the influencer is calculated for each cluster. The followers in the clusters are ranked based on interactions with the influencer. A potential media content related to the potential product is identified, and a placement recommendation to a given cluster is provided based on the influence factors for the clusters and on the follower ranks. Potential future trends are identified based on information related the influencer and are thus predictive and forward-looking, instead of reactive and backward-looking. The potential media contents and the strategic placement of the potential media contents leverages the anticipation of a trend due to the activities of the influencer.

### BACKGROUND

The targeting of content based on analyses of social media behavior of followers of influencers are known in the art. Such analyses seek to identify existing trends and to leverage these trends in the targeting of content. However, these analyses focus on the activities and profiles of the followers and are thus reactive or backward-looking.

### SUMMARY

Disclosed herein is a method for identifying potential product trends based on analysis of influencer media content and leveraging the identified trends, and a computer program product and system as specified in the independent claims. Embodiments of the present invention are given in the dependent claims. Embodiments of the present invention can be freely combined with each other if they are not mutually exclusive.

According to an embodiment of the present invention, the method analyzes metadata of at least one media content of an influencer from at least one content platform. At least one potential product is identified from the analysis of the metadata of the media content and a set of attributes for the potential product is extracted. Profile data of a plurality of followers of the influencer on the content platform is obtained, and the plurality of followers is clustered into a plurality of clusters based at least on geographic locations of the plurality of followers. An influence factor of the influencer is calculated for each of the plurality of clusters. The plurality of followers in the plurality of clusters are ranked based on follower interactions with the influencer on the content platform. At least one potential media content related to the potential product is identified, and a recommendation of placement of the potential media content to a given cluster of the plurality of clusters is provided based on the influence factor for each of the plurality of clusters and on the ranking of the plurality of followers in the plurality of clusters.

### BRIEF DESCRIPTION OF THE DRAWINGS

FIG. 1 illustrates an exemplary environment for identification of potential product trends according to some embodiments of the present invention.

FIG. 2 illustrates a follow chart for identifying potential product trends based on analysis of influencer media content, according to some embodiments of the present invention.

FIG. 3 illustrates a flow chart for generating product modification recommendations, according to some embodiments of the present invention.

FIG. 4 illustrates a flow chart for impact prediction of product modification recommendation adoption, according to exemplary embodiments of the present invention.

FIG. 5 illustrates a computer system for implementing exemplary embodiments of the present invention.

### DETAILED DESCRIPTION

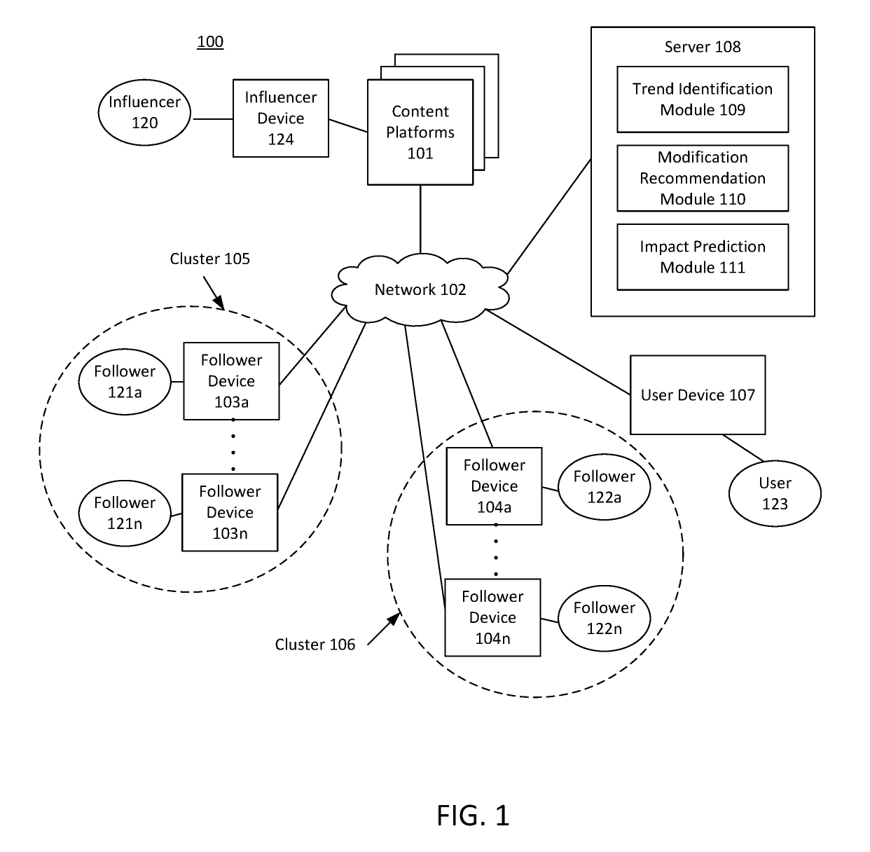

FIG. 1 illustrates an exemplary environment for identification of potential product trends according to some embodiments of the present invention. In the environment 100, a server 108 has access to one or more content platforms 101 over a network 102 on which influencers 120, via an influencer computing device 124, share media content with a plurality of followers 121a-121n and 122a-122n. Content platforms 101 can include social media platforms, blogs, websites, and other platforms on which an influencer 120 may interact with followers 121a-121n, 122a-122n. Each follower 121a-121n and 122a-122n can access the content platforms 101 over the network 102 using their respective follower computing devices 103a-103n and 104a-104n. For example, an influencer 120 may be a celebrity who shares media content via various social media platforms. The followers 121a-121n, 122a-122n “follow” the celebrity and may interact with the influencer 120 through “likes”, “shares”, or by posting comments about the celebrity's media content on the social media platforms. The server 108 includes a trend identification module 109 for identifying potential product trends based on an analysis of the influencer media content, a modification recommendation module 110 for generating product modification recommendations based on the potential product trends identified by the trend identification module 109, and an impact prediction module 111 for generating an impact prediction score for the product modification recommendation. The server 108 may provide the product modification recommendations and/or impact prediction scores to a user 123 via a user device 107. The user 123 may be a retailer, a manufacturer, a reseller, or any other user with access to the services provided by the server 108. Details of the trend identification module 109, the modification recommendation module 110, and the impact prediction module 11 are described further below.

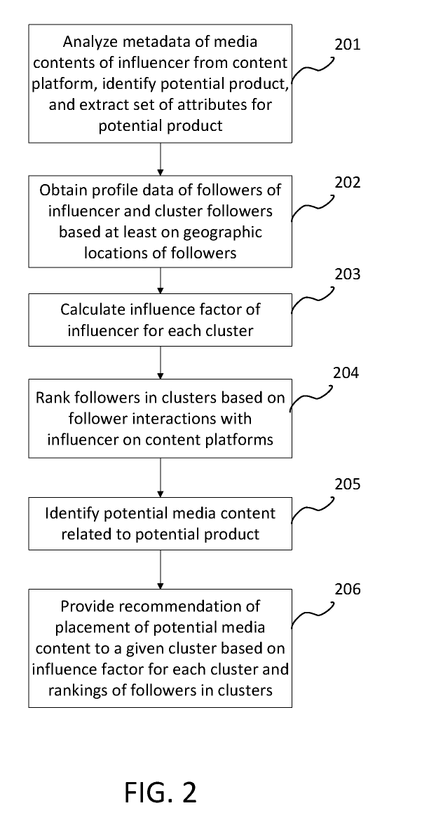

FIG. 2 illustrates a follow chart for identifying potential product trends based on analysis of influencer media content, according to some embodiments of the present invention. Referring to FIGS. 1 and 2, the trend identification module 109 accesses the metadata of the media content of an influencer 120 from at least one of the content platforms 101. The trend identification module 109 analyzes the metadata of at least one media content of the influencer 120, identifies at least one potential product, and extracts a set of attributes of the potential product (201). Image and text analyses may be performed on the metadata of the media content to identify the potential product and to build the potential product's attributes. The attributes include, but are not limited to, descriptions of design elements of the potential product. The potential product and its corresponding attributes are stored by the server 108. The trend identification module 109 also obtains the profile data of the plurality of followers of the influencer 120 on the content platforms 101 and clusters the followers into a plurality of clusters 105-106 according to at least their respective geographic locations (202). As illustrated in FIG. 1, the trend identification module 109 can form a first cluster 105 that includes followers 121a-121n and a second cluster 106 that includes followers 122a-122n. For example, the first cluster 105 includes followers located in the United States while the second cluster 106 includes followers located in Canada. Other attributes of the followers 121a-121n, 122a-122n (such as age, gender, interests, and other profile data, etc.) or their computing devices 103a-103n, 104a-104n (such as device type, network type, etc.) may be considered in clustering the followers. The trend identification module 109 further calculates an influence factor for the influencer 120 for each cluster 105-106 (203). The influence factor measures the level of influence the influencer 120 has in a particular cluster. The influence factor may be based on a weighted combination of parameters, which may include but are not limited to: the number of followers in a cluster; social sentiment of the interactions with influencer 120 by followers in the cluster; frequency of interactions with influencer 120 by followers in the cluster; types of media content of the influencer 120 with which followers in the cluster interact; time or season; and knowledge of influencer 120 in a topic associated with the media content. The trend identification module 109 further ranks the influencer's followers 121a-121n, 122a-122n based on follower activity with influencer 120 on the content platforms 101 (204). The follower activity may be based on a weighted combination of parameters, which may include but are not limited to: frequency of interactions by a follower; social sentiment of the interactions by the follower; type of interaction by the follower; contextual topic associated with a follower activity; level of engagement with other influencers by a follower; and content propagation rate related to a follower activity. The trend identification module 109 further identifies at least one potential media content that relate to the potential product identified from the analysis in block 201 (205). The potential media content may include photographs, news items, posts by other influencers, advertisement, etc. The trend identification module 109 then provides a recommendation of placement of the potential media content to a given cluster of the plurality of clusters 105-106 based on the influence factor of each cluster 105-106 and the follower rankings of followers in the plurality of clusters 105-106 (206). In this exemplary embodiment, a composite score is calculated from the influence factor and the follower rankings for each cluster. The clusters 105-106 are then ranked per the composite score, and the recommendation of placement is generated based on the ranking of the clusters. For example, the trend identification module 109 may be configured to generate recommendations of placement for a predetermined top percentage or number of the ranked clusters.

In the above described manner, the exemplary embodiments identify potential future trends based on information related the influencer. This is contrary to existing approaches, where the interactions and/or media contents of the followers are analyzed to identify existing trends. The exemplary embodiments are thus predictive and forward-looking, instead of reactive and backward-looking. The potential media contents identified by the trend identification module 109 and the strategic placement of the potential media contents thus leverages the anticipation of a trend due to the activities of the influencer.

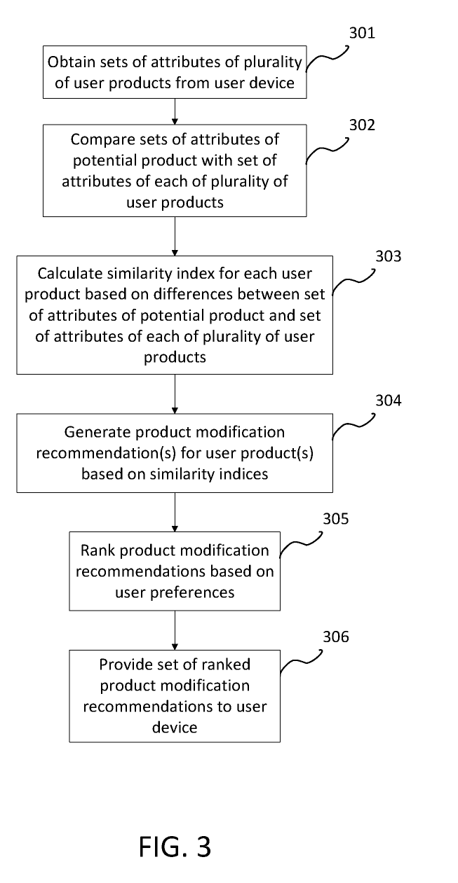

In addition to identifying potential trends as described above with reference to FIG. 2, exemplary embodiments of the present invention may also assist in the leveraging of the potential trend by generating product modification recommendations based on the analysis performed according to FIG. 2. FIG. 3 illustrates a flow chart for generating product modification recommendations, according to some embodiments of the present invention. Upon determining that a user 123 is requesting product modification recommendations, the modification recommendation module 110 obtains sets of attributes of a plurality of user products via a user device 107 (301). Each set of attributes describe a corresponding user product of the plurality of user products, extracted in block 201 (see FIG. 2). The attributes include, but are not limited to, descriptions of design elements of each user product. The modification recommendation module 110 compares the set of attributes of the potential product with the sets of attributes of the plurality of user products (302). A similarity index is then calculated for each of the plurality of user products based on the difference between the set of attributes of the potential product and the set of attributes of each user product (303). The similarity index indicates how similar the design elements of a given user product is to the design elements of the potential product. In some exemplary embodiments, the attributes may be weighted in the calculation of the similarity index to reflect the importance of a corresponding design element. Based on the similarity indices of the plurality of user products, one or more product modification recommendations for the user products are generated (304). In some embodiments, the product modification recommendations include recommendations to add a design element, change a design element, or remove a design element from a corresponding user product. The product modification recommendations are then provided to the user 123 via the user device 107. Optionally, the modification recommendation module 110 ranks the product modification recommendations based on user preferences (305) and provides a set of the ranked product modification recommendations to the user 123 (306). Example user preferences may include but are not limited to: geographic locations; target followers; and level of feasibility of adoption of the recommended modification. The set may, for example, be a top number of the ranked product modification recommendations.

In the above described manner, the product modification recommendations assist in leveraging the potential trend identified according to FIG. 2. Exemplary embodiments of the present invention not only identify potential trends based on an analysis of the influencer, they generate product modification recommendations through an analysis of the user products in view of the potential product extracted from the media contents of the influencer, enabling users to anticipate, or even create, the potential trends.

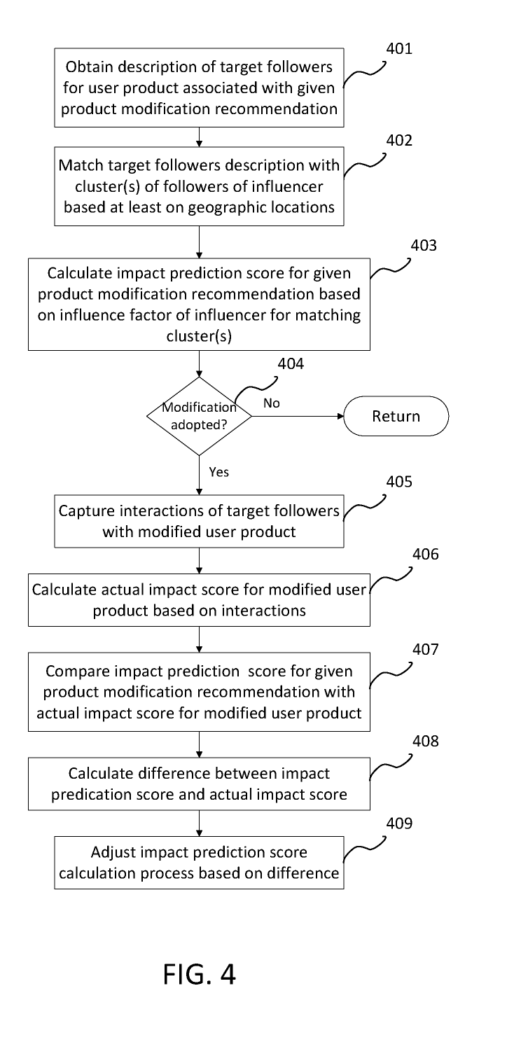

Optionally, exemplary embodiments of the present invention may further predict the impact of adoption of a particular product modification recommendation. FIG. 4 illustrates a flow chart for impact prediction of product modification recommendation adoption, according to exemplary embodiments of the present invention. The impact predication module 111 of the server 108 calculates an impact prediction score for a user product associated with a particular product modification recommendation, based on the influence factor (calculated in block 203; see FIG. 2) and based on the correlation between target followers for the user product and the influencer 120. In some embodiments, the user 123 selects for which product modification recommendations the impact prediction score is generated. The impact predication module 111 obtains a description of a plurality of target followers for a given user product associated with a given product modification recommendation (401). The target followers may be described based on geographic location and/or other profile information for the followers. The target followers may be defined by the user 123 through the configuration of user preferences or be defined as a configurable parameter by the impact prediction module 111. The impact prediction module 111 matches the target follower description with at least one of the clusters of followers 105-106 of the influencer 120, based at least on the geographic locations associated with the target followers and the clusters 105-106 (402). The impact prediction module 111 then calculates an impact prediction score for the given product modification recommendation based on the influence factor of the influencer 120 for the matching cluster(s) (403). The impact predication score can be configured to measure the potential impact on various activities, such as sales, social media activities, click-throughs, website visits, etc. Data specific to one of more of these activities may be considered in the prediction score calculation. For example, the impact prediction module 111 may determine whether the influencer's activities on the content platforms 101 as related to the media content is new, and if so, determine the level of appreciation of the followers in response to the media content (e.g. increased average number of “shares” or “likes”; rise in positive sentiment of the followers; and level of popularity of the media content). The impact prediction score is then calculated based on a weighted combination of these parameters and the influence factor for the influencer 120.

If the user 123 adopts the given product modification recommendation (404), i.e., modifies the given user product according to the given product modification recommendation, then the impact predication module 111 can be used to evaluate the actual impact of the product modification. The impact prediction module 111 captures the interactions of the target followers with the modified user product (405) and calculates an actual impact score for the modified user product based on the interactions (406). The modified user product is the given user product modified according to the given product modification recommendation. The interactions captured may include, for example, a click-through rate, page impressions, purchases, referrals, etc. A weighted combination of the interactions is used to calculate the actual impact score. The weights may be assigned based on the relative importance of the interactions. For example, a page impression parameter (X) may be configured with a weight of 0.2, a number of referrals parameter (Y) may be configured with a weight of 0.5, and a number of actual purchases parameter ( ) may be configured with a weight of 0.8. The configured weights reflect the relative important of each of these interaction types. An actual impact score can then be calculated as (0.2*X)+(0.5*Y)+(0.8*Z). The impact predication module 111 compares the impact prediction score for the given product modification recommendation with the actual impact score for the modified user product (407) and calculates a difference between the impact prediction score for the given product modification recommendation and the actual impact score for the modified user product (408). The impact predication module 11 then adjusts the impact prediction score calculation process based on the difference (409). For example, the weights of the interactions may be adjusted to improve the precision of the impact predication score calculation process. In this manner, a feedback or learning loop is created that improves the impact prediction using real-world data.

Consider an example of a celebrity who posts a photograph on a social media platform, with text accompanying the photograph. In the photograph, the celebrity is wearing a t-shirt with a set of design elements. In this example, the celebrity is the influencer 120, and the photograph and the accompanying text comprise the media content. Referring to FIG. 2, the trend identification module 109 accesses the metadata of the photograph and text. The trend identification module 109, using image and text analyses, analyzes the metadata of the photograph and text, identifies a potential product, and extracts a set of attributes for the potential product (201). Assume in this example, that the t-shirt shown in the photograph is identified as a potential product, and the set of attributes extracted describe the design elements of the t-shirt. The trend identification module 109 also obtains the profile data of the celebrity's followers on the social media platform and clusters the followers based at least on their respective geographic locations (202). The trend identification module 109 calculates an influence factor of the celebrity for each cluster of followers (203) and ranks the followers in the clusters based on their respective interactions with the celebrity on the social media platform (204). The trend identification module 109 also identifies potential media contents related to the t-shirt (205). Assume in this example that text analysis indicates that the text accompanying the photograph refers to a social issue. News items relating to the social issue may be identified as a potential media content. An advertisement for sale of the t-shirt may also be identified as a potential media content. The trend identification module 109 generates and provides a recommendation of the placement of the news items and/or the advertisement (206). For example, the recommended placement for the news items may be in cluster(s) where a combination of a level of positivity of follower interactions with the post and the influence factor meets a predetermined threshold. For another example, the recommended placement for the advertisement may be in cluster(s) where a combination of follower demographics and the influence factor meets another predetermined threshold.

Assume further in this example, that a retailer offers a plurality of t-shirts. The retailer is thus the user 123 and the plurality of t-shirts is the plurality of user products. Referring to FIG. 3, the modification recommendation module 110 obtains sets of attributes of the plurality of t-shirts (301), where each set of attributes describe the design elements of a corresponding t-shirt of the plurality of t-shirts. The modification recommendation module 110 compares the set of attributes of the celebrity's t-shirt with the set of attributes of each of the retailer's t-shirts (302). Optionally, the plurality of t-shirts can be filtered using any number of parameters prior to the comparison such that a subset of the retailer's t-shirts is compared. The attributes of the t-shirts that can be compared includes but are not limited to: color; collar shape; sleeve length; lettering; graphics; pockets; and male/female/unisex. A similarity index is then calculated for each of the retailer's t-shirts based on the differences between the set of attributes of each retainer t-shirt and the set of attributes of the celebrity's t-shirt (303). The modification recommendation module 110 generates one or more product modification recommendations for the retailer t-shirts based on their respective similarity indices (304). For example, assume that the celebrity's t-shirt is of a certain color and includes a specific graphic. Assume also that the similarity index for two of the retailer t-shirts meet a predetermined threshold, where a first retailer t-shirt differs from the celebrity's t-shirt in color, and a second retailer t-shirt differs from the celebrity's t-shirt in that it does not include the specific graphic. The modification recommendation module 110 can generate a first product modification recommendation for the first retailer t-shirt be modified to be of the certain color and a second product modification recommendation for the second retailer t-shirt to be modified to include the specific graphic. The modification recommendation module 110 can rank the product modification recommendations based on user preferences (305). For example, a user preference can be a degree of feasibility for color and graphic design elements. Assume that the degree of feasibility for color is higher than for graphic design elements, indicating that it's more feasible for the retainer to modify the color of its t-shirts than to modify graphic design elements. The modification recommendation module 110 can then rank the first product modification recommendation higher than the second product modification recommendation. The modification recommendation module 110 then provides a set of the ranked product modification recommendations to the retailer via its user device 107 (306). Assume in this example that the user preferences set the number of product modification recommendations such that both the first and second product modification recommendations are provided.

In addition to the product modification recommendations, the impact prediction module 111 can also generate an impact prediction score for the first and/or second product modification recommendations. Referring to FIG. 4, the impact prediction module 111 obtains a description of the target followers for the first retailer t-shirt associated with the first product modification recommendation (401). The impact prediction module 111 matches the target followers with one or more clusters of followers of the celebrity based at least on the geographic locations associated with the cluster(s) (402). For example, assume that the target followers are defined as followers located in the United States and is between the ages of 21-34. The impact prediction module 111 matches the target followers with clusters associated with the United States and with the ages between 21 and 34. The impact prediction module 111 calculates an impact prediction score for the first product modification recommendation based on the influence factor of the celebrity in these matching clusters (403). For example, sales data for the first t-shirt in the United States and with consumers between the ages of 21 and 34 can be provided to the impact prediction module 111 by the retailer. The impact prediction module 111 can consider the sales data in calculating the impact prediction score for the first product modification recommendation. In this case, the impact prediction module 111 would indicate the predicted impact the change in color will have on the sale of the first t-shirt to followers in the matching clusters. The same process can be repeated to provide an impact prediction score for the second product modification recommendation.

Assume that the retailer adopts the first product modification recommendation and offers for sale a modified first t-shirt in the recommended color. The impact predication module 111 can track the actual impact of the modification and use this data to improve the impact prediction score calculation process. Referring again to FIG. 4, the impact prediction module 111 captures the interactions of the target followers with the modified first t-shirt (405), such as click-through rate, page impressions, purchases, referrals, etc. The captured interactions may be through the retailer website, sales data, social media activities, etc. The interactions may be weighted to reflect the relative impact of the interactions on the sales outcome. Using the captured interactions, the impact prediction module 111 calculates an actual impact score for the modified first t-shirt (406). Assuming that the impact prediction score is configured to predict impact on the sale of the t-shirt prior to modification, then the actual impact score is configured to measure the actual impact of the modification on the sale of the modified first t-shirt. The impact prediction module 111 compares the impact prediction score with the actual impact score (407), and calculates a difference between the two scores (408). Based on the difference, the impact prediction module 111 can adjust the impact prediction score calculation process (block 403), such that the impact prediction score calculation process may be modified to improve accuracy.

Although the example above is described in the context of predicting and tracking the impact on sales, embodiments of the present invention can be used to predict and track other types of activities, such as social media activities, click-throughs, website visits, etc.

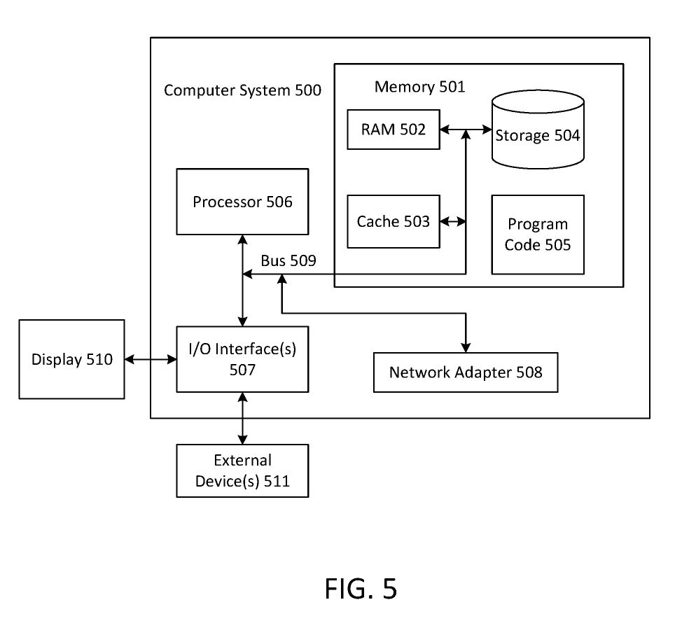

FIG. 5 illustrates a computer system for implementing exemplary embodiments of the present invention. The computer system 100 may be comprised in any combination of the server 108, the follower devices 103a-103n, 104a-104n, and the user device 107. The computer system 500 is operationally coupled to a processor or processing units 506, a memory 501, and a bus 509 that couples various system components, including the memory 501 to the processor 506. The bus 509 represents one or more of any of several types of bus structure, including a memory bus or memory controller, a peripheral bus, an accelerated graphics port, and a processor or local bus using any of a variety of bus architectures. The memory 501 may include computer readable media in the form of volatile memory, such as random access memory (RAM) 502 or cache memory 503, or non-volatile storage media 504. The memory 501 may include at least one program product having a set of at least one program code module 505 that are configured to carry out the functions of embodiment of the present invention when executed by the processor 506. The computer system 100 may also communicate with one or more external devices 511, such as a display 510, via I/O interfaces 507. The computer system 500 may communicate with one or more networks via network adapter 508.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
analyzing, by a server, metadata of at least one media content of an influencer from at least one content platform;
identifying, by the server, at least one potential product from the analysis of the metadata of the media content;
extracting, by the server, a set of attributes for the potential product;
obtaining, by the server, profile data of a plurality of followers of the influencer on the content platform;
clustering, by the server, the plurality of followers into a plurality of clusters based at least on geographic locations of the plurality of followers;
calculating, by the server, an influence factor of the influencer for each of the plurality of clusters;
ranking, by the server, the plurality of followers in the plurality of clusters based on follower interactions with the influencer on the content platform;
identifying, by the server, at least one potential media content related to the potential product; and
providing, by the server, a recommendation of placement of the potential media content to a given cluster of the plurality of clusters based on the influence factor for each of the plurality of clusters and on the ranking of the plurality of followers in the plurality of clusters.

2. The method of claim 1, wherein the providing of the recommendation of the placement of the potential media content comprises:
calculating, by the server, a composite score for each of the plurality of clusters from the influence factor and the rankings for the plurality of followers in each of the plurality of clusters;
ranking, by the server, the plurality of clusters based on the composite score; and
generating, by the server, the recommendation of the placement of the potential media content based on the ranking of the plurality of clusters.

3. The method of claim 1, further comprising:
obtaining, by the server, a set of attributes of each of a plurality of user products from a user device;
comparing, by the server, the set of attributes of the potential product with the set of attributes of each of the plurality of user products;
calculating, by the server, a similarity index for each of the plurality of user products based on a difference between the set of attributes of the potential product and the set of the attributes of each of the plurality of user products;
generating, by the server, a plurality of product modification recommendations for the plurality of user products based on the similarity index for each of the plurality of user products; and
providing, by the server, the plurality of product modification recommendations to a user device.

4. The method of claim 3, wherein the providing of the plurality of product modification recommendations to the user device comprises:
ranking, by the server, the plurality of product modification recommendations based on a set of user preferences from the user device; and
providing, by the server, a set of ranked product modification recommendations to the user device.

5. The method of claim 3, further comprising:
obtaining, by the server, a description of a plurality of target followers for a given user product associated with a given product modification recommendation of the plurality of product modification recommendations;
matching, by the server, the description of the plurality of target followers with at least one of the plurality of clusters based at least on geographic location associated with the plurality of target followers and the plurality of clusters; and
calculating, by the server, an impact prediction score for the given product modification recommendation based on the influence factor of the influencer for the at least one of the plurality of clusters matching the description of the plurality of target followers.

6. The method of claim 5, further comprising:
capturing, by the server, a plurality of interactions of the plurality of target followers with a modified user product, wherein the modified user product comprises the given user product has been modified according to the given product modification recommendation;
calculating, by the server, an actual impact score for the modified user product based on the plurality of interactions;
comparing, by the server, the impact prediction score for the given product modification recommendation with the actual impact score for the modified user product;
calculating, by the server, a difference between the impact prediction score for the given product modification recommendation and the actual impact score for the modified user product; and
adjusting, by the server, a process for calculation of the impact prediction score based on the difference between the impact prediction score for the given product modification recommendation and the actual impact score for the modified user product.
